(19) United States
(12) Patent Application Publication
(10) Pub. No.: US 2007/0228709 A1
(43) Pub. Date: Oct. 4, 2007

(54) Airbag with gas diffuser

(75) Inventor: Michel G. Khouri, Birmingham, MI (US)

Correspondence Address: FOLEY AND LARDNER LLP;SUITE 500, 3000 K STREET NW, WASHINGTON, DC, 20007, US

(73) Assignee: TK HOLDINGS, INC.

(21) Appl. No.: 11/727,767

(22) Filed: Mar. 28, 2007

Related U.S. Application Data
(60) Provisional application No. 60/743,988, filed on Mar. 30, 2006.

(51) Int. Cl. B60R 21/26; B60R 21/23

(52) U.S. Cl. 280/740; 280/743.1

(57) ABSTRACT

An airbag includes a gas diffuser that includes a plurality of apertures and is formed of a fabric material. The gas diffuser is integrally formed with at least a portion of an airbag cushion. The airbag may be a curtain style airbag or another type of airbag.

### CROSS-REFERENCE TO RELATED PATENT APPLICATIONS

This application claims the benefit of U.S. Provisional Application No. 60/743,988 filed Mar. 30, 2006, the disclosure of which is incorporated herein by reference in its entirety.

### BACKGROUND

The present application relates to an airbag, and more specifically to an integrated gas diffuser for an airbag (e.g., a curtain airbag).

Inflatable airbags have become standard equipment in modern automobiles. Such airbags typically include a bag portion that inflates when a predetermined condition is met (e.g., an automobile impact). Airbags may be provided at numerous locations within the passenger compartment, including within steering wheels, in seats, along pillars of the vehicle, in dashboards, and in other locations.

Airbag assemblies typically include a mechanism for diffusing gas from a gas canister or inflator into various portions of an airbag. For example, where an airbag is internally divided into a number of cells or chambers, it is desirable to diffuse the gas such that each of the separate cells inflates simultaneously (rather than sequentially). To do so, a tube or hose formed of a metal (e.g., aluminum) and having a number of holes formed therein is used as a sort of manifold system to distribute the gas to the various portions of the airbag.

One disadvantage associated with the use of a separate tube is that it adds cost to the production of the airbag, both in terms of the additional component required and the fact that it must be separately manufactured and coupled with the airbag. Another associated disadvantage is that the material (typically a metal) from which the diffuser is formed adds weight to the airbag assembly (and hence, to the assembled vehicle). It would be desirable to provide an airbag assembly that overcomes these and other disadvantages associated with conventional airbag assemblies as will be described in more detail herein.

### SUMMARY

An exemplary embodiment relates to an airbag that includes a gas diffuser that includes a plurality of apertures and is formed of a fabric material. The gas diffuser is integrally formed with at least a portion of an airbag cushion.

Another exemplary embodiment relates to an airbag that includes a first fabric panel configured to define both at least one wall of an airbag cushion and a gas diffuser for the airbag, the gas diffuser having a generally tubular shape and having a plurality of apertures formed therein.

An exemplary embodiment relates to a method of producing an airbag that includes providing a first fabric panel and forming a generally tubular channel from a first portion of the first fabric panel. The method also includes forming an inflation chamber from a second portion of the first fabric panel.

### BRIEF DESCRIPTION OF THE DRAWINGS

These and other features, aspects, and advantages of the present invention will become apparent from the following description and the accompanying exemplary embodiments shown in the drawings, which are briefly described below.

FIG. 1 is a cross-sectional side view of an airbag (e.g., a curtain airbag) according to an exemplary embodiment.

FIG. 2 is a plan view of a portion of the airbag shown in FIG. 1 illustrating a panel having an adhesive applied thereto.

FIG. 3 is a plan view of the portion of the airbag shown in FIG. 2 illustrating a first fold of the panel.

FIG. 4 is a perspective view of the portion of the airbag shown in FIG. 3 illustrating a second fold of the panel.

FIG. 5 is a cross-sectional side view of a curtain airbag similar to that shown in FIG. 1 made from a single panel of airbag material.

FIG. 6 is a perspective view of the airbag shown in FIG. 1.

FIG. 7 is a plan view of the portion of the airbag shown in FIG. 2 illustrating adhesive applied to the panel to form cells within the airbag.

FIG. 8 is a cross-sectional side view of an airbag according to an exemplary embodiment.

FIG. 9 is a plan view of a portion of the airbag shown in FIG. 8 illustrating a panel having an adhesive applied thereto.

FIG. 10 is a plan view of the portion of the airbag shown in FIG. 9 illustrating a first fold of the panel.

FIG. 11 is a perspective view of the portion of the airbag shown in FIG. 10 illustrating a second fold of the panel.

FIG. 12 is a cross-sectional side view of a curtain airbag similar to that shown in FIG. 8 made from a single panel of airbag material.

### DETAILED DESCRIPTION

According to an exemplary embodiment, an airbag assembly is provided that includes an integrated gas diffuser that is formed from the material used to form the panels of the airbag. In so doing, disadvantages associated with conventional gas diffusers that are manufactured separately and thereafter coupled to the airbag may be reduced or eliminated. For example, the airbag assembly will weigh less and may be assembled more quickly and simply than if a metal gas diffuser were used.

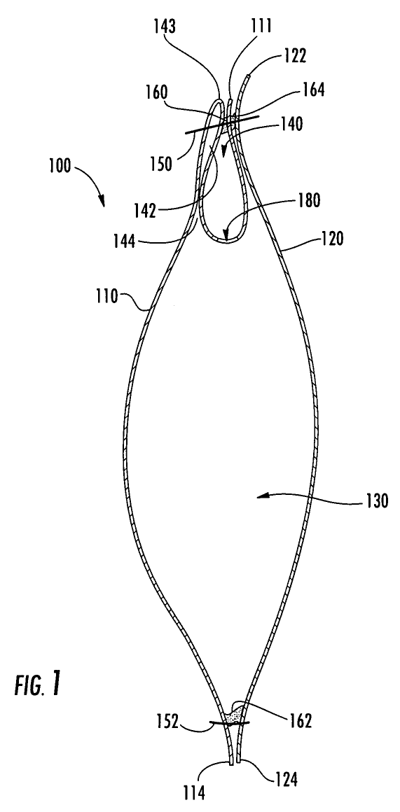

FIG. 1 is a cross-sectional side view of a curtain airbag 100 according to an exemplary embodiment, and FIG. 6 is a perspective view of the airbag 100. The airbag 100 may be a curtain airbag that is configured to descend from a B or C pillar or roof line of a vehicle (or any other suitable vehicle location) to protect the head and upper torso of an occupant during a crash or rollover situation. According to other exemplary embodiments, the airbag 100 may be any other suitable type of airbag such as, for example, a driver side airbag, a passenger side airbag, a side airbag, or a knee airbag.

The airbag includes a first fabric sheet or panel 110 and a second fabric sheet or panel 120 that are coupled together (e.g., using a mechanical fastener such as an adhesive and/or thread) to form a chamber 130 (i.e., an inflation chamber) that is configured to inflate upon the introduction of a gas into the airbag and to cushion a vehicle passenger in the event of an airbag deployment. The panels 110 and 120 may be woven or nonwoven and formed of any suitable type of material. According to an exemplary embodiment, the panels 110, 120 are formed of a nylon material such as a ballistic-grade nylon material.

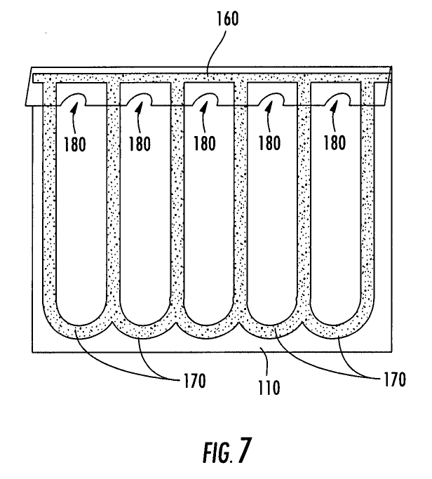

According to an exemplary embodiment, the chamber 130 is subdivided into a plurality of cells or chambers. For example, FIG. 7 illustrates the use of an adhesive 170 that may be used to form the individual cells or chambers when the fabric panels 110 and 120 are brought into contact. The chambers may be reinforced with stitching or thread according to an exemplary embodiment. According to another exemplary embodiment, the chamber is not subdivided (i.e., it has only a single cell or chamber).

According to an exemplary embodiment, the first panel 110 is configured and arranged such that it defines a channel or passage 140 (e.g., a tube chamber) that may act as an integrated gas diffuser for the airbag. A plurality of holes or apertures 180 are provided near the bottom of the channel 140 and are aligned with features in the airbag (i.e., the individual cells or chambers) to route gas from an inflator (not shown) to the appropriate locations within the airbag. In this manner, the channel 140 may operate in a manner similar to the manner in which a conventional rigid tube diffuser would operate. The channel 140 may be formed using any suitable method, such as those which are described below in greater detail.

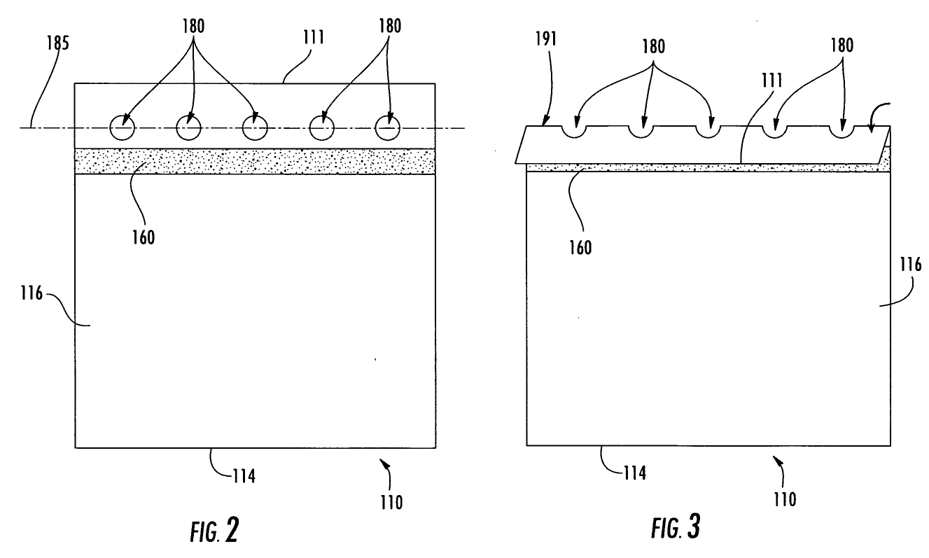

FIG. 2 is a plan view of the first panel 110 of the airbag 100. The holes or apertures 180 are provided in a row that is substantially parallel to a first or upper edge 111 of the first panel 110. According to other exemplary embodiments, a greater or lesser number of apertures may be provided having any of a variety of sizes, shapes, or configurations. The apertures need not be arranged in generally linear fashion as shown in FIG. 2 according to other exemplary embodiments. According to still other exemplary embodiments, the apertures may be formed in the first panel 110 after the folding operations described below.

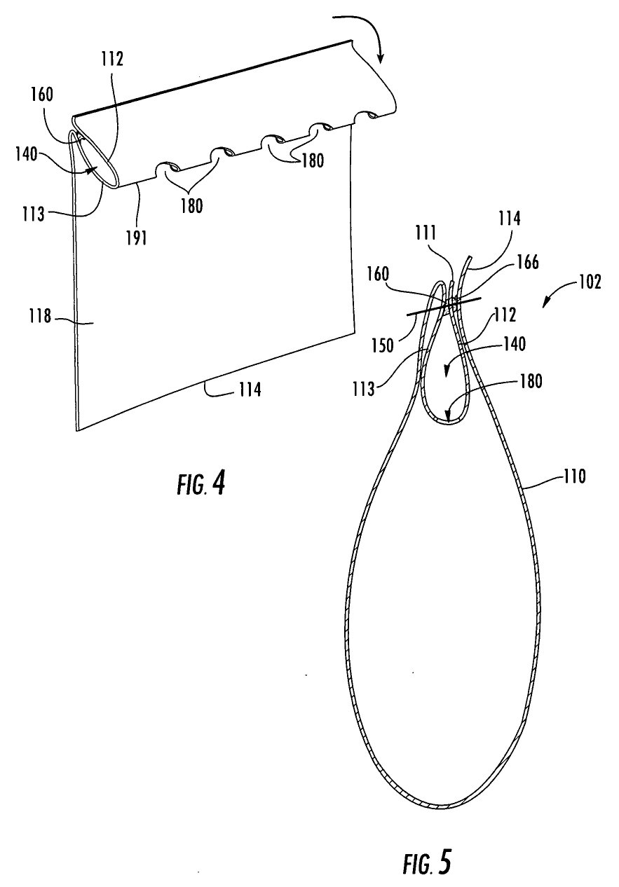

As shown in FIGS. 2-3, the first edge 111 of the first panel 110 is folded about an axis 185 toward a first surface 116 of the first panel 110 to form a first fold line or edge 191. The axis 185 is generally parallel to the first edge 111 of the first panel 110 and intersects the apertures 180. According to other exemplary embodiments, the axis may be at a different location (e.g., such that it doesn't intersect the apertures 180). As shown in FIGS. 1 and 4, the apertures 180 are positioned such that they are at the first fold line 191.

According to an exemplary embodiment, an adhesive 160 is provided on the first surface 116 of the first panel, and the folded portion 112 of the first panel 110 contacts the adhesive 160 upon being folded toward the first surface 116. The adhesive acts to provide a seal for the edge of the channel 140 defined by the folded portion 112 and a portion 113 of the first panel 110. In addition to the adhesive, the chamber may be secured by stitching or sewing (e.g., with thread) through the adhesive after the channel 140 is formed (either at this point or when all of the components of the airbag are assembled as further described below).

FIG. 4 illustrates a second folding step in which the portions 112, 113 defining the channel 140 are folded toward a second surface 118 of the first panel 110 (the first surface 116 and the second surface 118 may alternatively be referred to as the front and back surfaces of the first panel 110, respectively). Once the second folding step is complete, the apertures 180 will be positioned as shown in FIGS. 1 and 6 and a second channel 142 will be defined by portions of the first panel 110. Because the upper edge 143 of the second channel 142 is effectively sealed since it has no apertures formed therein, no adhesive is provided to seal the channel 142 from the chamber 130 of the airbag 100. According to other exemplary embodiments, an adhesive may be provided near the upper edge 143, near the opening 144 of the channel 142, or at any suitable location therebetween. According to an embodiment in which adhesive is provided near the opening 144 of the channel 142, a line of adhesive similar to that shown in FIG. 2 may be applied to the second surface 118 of the first panel 110 such that when the portions 112, 113 defining the channel 140 are folded such that the channel 140 is in contact with the second surface 118, the adhesive seals the resulting channel 142.

As shown in FIGS. 1 and 6, the second panel 120 is then coupled to the first panel 110. As described above, an optional adhesive 170 is provided on the first panel (as shown in FIG. 7) that is operative to define cells or chambers within the airbag 110 when the second panel 120 is coupled to the first panel 110.

To couple the second panel 120 to the first panel 110, a first or upper edge 122 of the second panel 120 is provided proximate the first edge 111 of the first panel and the upper edge of the channel 140. An adhesive 164 is applied between the first panel 110 and the second panel 120. The panels may also be sewn or stitched (as shown by line 150 in FIG. 1) through the adhesive to provide more secure coupling between the panels. According to other exemplary embodiments, the sew line may be provided at locations other than directly through the adhesive.

The first panel 110 and second panel 120 are also coupled together at lower edges thereof, as shown in FIG. 1. A second or lower edge 124 of the second panel 120 is provided proximate a second or lower edge 114 of the first panel 110, and an adhesive 162 is provided to secure the edges together. The panels may also be sewn or stitched (as shown by line 152 in FIG. 1) at the location of the adhesive 162 or at another suitable location. It should also be noted that the lateral edges of the panels may also be coupled together using adhesives, sewing, and/or other methods to seal the chamber 130. Additionally, one end of the chamber 140 may be sealed (with the other end configured for coupling to an inflator (not shown) for the airbag.

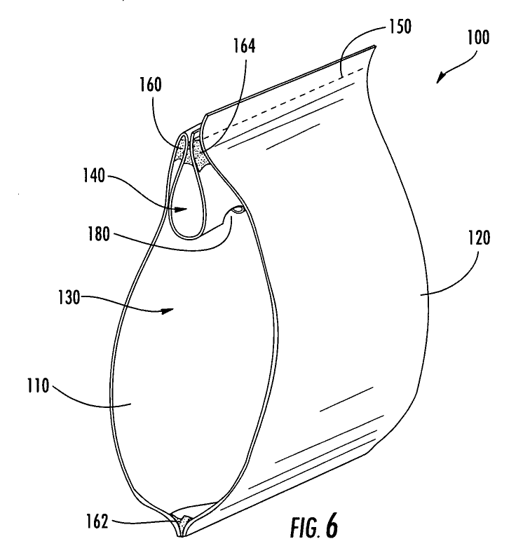

According to another exemplary embodiment as shown in FIG. 5, the second panel 120 may be eliminated, and the second edge 114 of the panel 110 may be folded such that it is positioned adjacent the first edge 111 of the panel 110. An adhesive 166 may be provided to secure the portions of the panel together, and a sewing step similar to that described with respect to FIG. 1 may be used. One advantageous feature of such a configuration is that the steps required to secure the lower edges together (e.g., applying adhesive, sewing, etc.) and the necessity to store and assemble two pieces of fabric together may be eliminated.

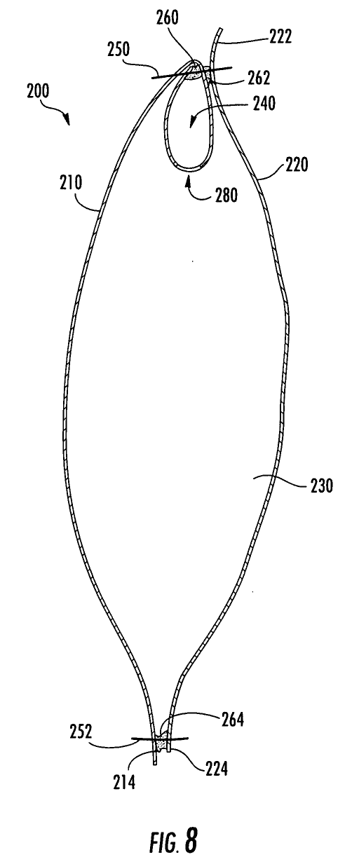

As described above, the channel 140 may be formed using any suitable method. FIGS. 8-12 illustrate a folding method according to another exemplary embodiment. The folding method shown in FIGS. 8-11 differs from that shown in FIGS. 1-4 in that instead of folding the portions 112, 113 backward toward a second surface 118 of the panel, the portions 112, 113 are instead folded forward toward the first surface 116 of the panel, which provides a somewhat different configuration as can be appreciated by reviewing FIGS. 1 and 8 side-by-side. For clarity, FIGS. 8-12 include features similar to those shown in FIGS. 1-4 and differ by 100 (e.g., airbag 100 is referred to as airbag 200, etc.).

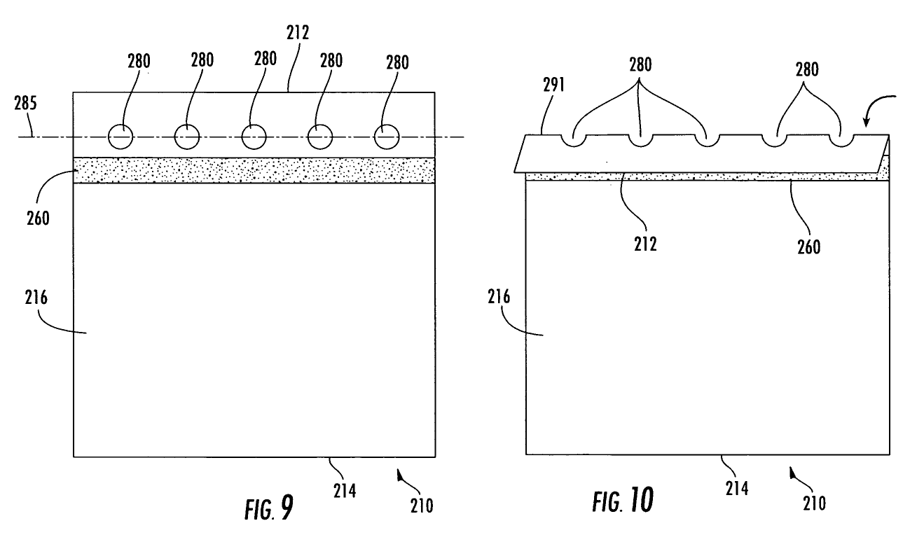

As shown in FIGS. 9-10, a first folding operation is performed in which a first or upper edge 212 of a first panel 210 is folded about an axis 285 that intersects apertures or holes 280 to form a fold line 291 in a manner similar to that shown in FIGS. 2-3. The first fold thus takes the first edge 212 and folds it toward a first surface 216 of the first panel 210 to define the channel 240.

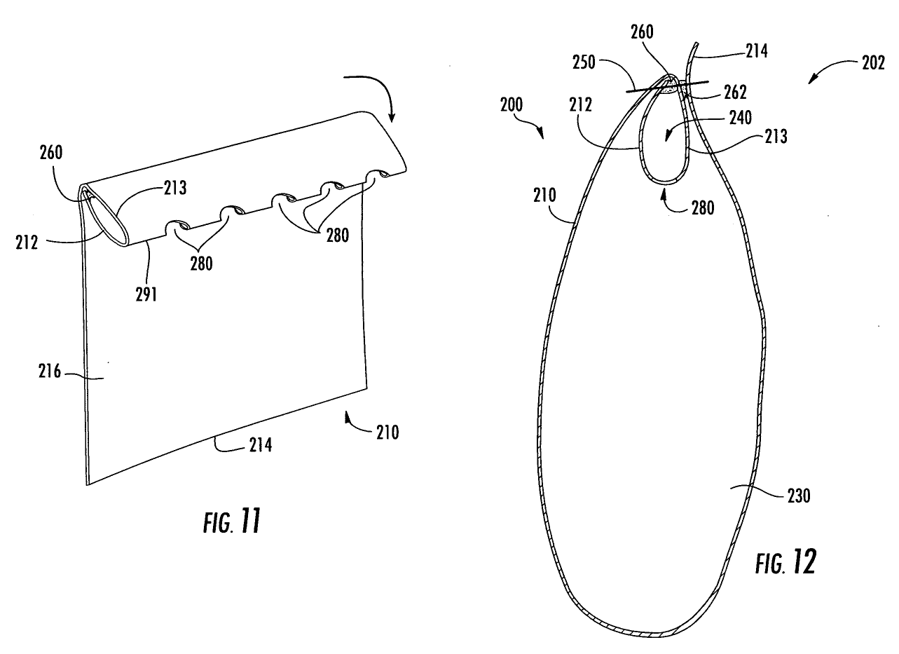

As shown in FIG. 11, the first and second portions 212, 213 of the first panel 210 that define the chamber 240 are then folded again toward the first surface 216 of the first panel 210. The portion 212 is provided adjacent the first surface 216 as shown in FIG. 8 (and in contrast to FIG. 1, where the portion 113 is provided adjacent the first surface 116). Adhesive 262 may be provided to secure a second panel 220 to the first panel 210 proximate a first or upper edge 222 of the second panel 220 and an adhesive 264 may be provided to secure the second panel 220 to the first panel 210 proximate the lower edges 214, 224 of the first and second panels 210, 220 (alternatively, as shown in FIG. 12, the lower edge 214 of the second panel may be folded toward the top of the airbag and secured in place with an adhesive 266. Again, the airbag may be sewn shut (as indicated by sewing lines 250 and 252). Individual cells or chambers (not shown) may also be provided within the chamber 230 of the airbag 200 in a manner similar to that shown and described with respect to FIG. 7.

Although folded in a slightly different manner, both the airbags shown in FIGS. 1 and 8 each include an integrated gas diffuser in the form of a channel 140, 240 that has apertures 180, 280 provided therein to distribute gas to select locations within the chambers 130, 230.

The adhesive used to secure the panels together (or to secure various portions of a single panel together) may be a silicone adhesive or any other suitable type of adhesive. The adhesive may be provided as a bead of adhesive applied to the fabric panels 110 and/or 120. Further, the location and amount of the adhesives are shown for exemplary purposes only. The type, amount and location of the adhesive 160 and sewn seams 150 may vary as appropriate.

According to other exemplary embodiments, other means of securing the panels together (or to secure various portions of a single panel together) may be used. For example, according to an exemplary embodiment, a coating may be applied to the fabric that may subsequently be cured in a radio frequency (RF) welding process, an ultrasonic welding process, a pulse welding process, a heat setting process, or other suitable processes. The coating may comprise a polymeric material and may be provided on one or both surfaces that are to be coupled together.

Those reviewing the present disclosure will appreciate that various advantages may be obtained utilizing the systems and methods described herein. For example, the integrated diffuser as described herein may provide an alternative to relatively complicated and costly conventional diffusers using separate tubing. For example, the time required to drop the airbag cushion and the cost and assembly time for a diffuser may be reduced as compared to conventional diffuser systems. Various components may also be eliminated as compared to conventional assemblies, since the integrated diffuser eliminates or reduces the need to have a rigid metal pipe for a diffuser and the cushion material (fabric panels) itself may be utilized to diffuse inflation gas.

It should be noted that references to relative positions (e.g., “top” and “bottom”) in this description are merely used to identify various elements as are oriented in the FIGURES. It should be recognized that the orientation of particular components may vary greatly depending on the application in which they are used.

For the purpose of this disclosure, the term “coupled” means the joining of two members directly or indirectly to one another. Such joining may be stationary in nature or moveable in nature. Such joining may be achieved with the two members or the two members and any additional intermediate members being integrally formed as a single unitary body with one another or with the two members or the two members and any additional intermediate members being attached to one another. Such joining may be permanent in nature or may be removable or releasable in nature.

The construction and arrangement of the system as shown in the various exemplary embodiments is illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited in the claims. For example, elements shown as integrally formed may be constructed of multiple parts or elements, the position of elements may be reversed or otherwise varied and the nature or number of discrete elements or positions may be altered or varied. The order or sequence of any process or method steps may be varied or re-sequenced according to alternative embodiments. Other substitutions, modifications, changes and omissions may be made in the design, operating conditions and arrangement of the various exemplary embodiments without departing from the scope of the present inventions as expressed in the appended claims.

What is claimed is:

1. An airbag comprising:
a gas diffuser comprising a plurality of apertures, the gas diffuser formed of a fabric material and integrally formed with at least a portion of an airbag cushion.

2. The airbag of claim 1, wherein the gas diffuser has a tubular shape and is formed from a first sheet of material.

3. The airbag of claim 2, wherein a first portion of the first sheet of material is coupled to second portion of the first sheet of material to form the gas diffuser.

4. The airbag of claim 3, further comprising an adhesive for coupling the first portion to the second portion.

5. The airbag of claim 2, wherein the first sheet of material also defines at least a portion of an inflation chamber for the airbag.

6. The airbag of claim 5, further comprising a second sheet of material coupled to the first sheet of material to define the inflation chamber.

7. The airbag of claim 5, wherein the inflation chamber is divided into a plurality of cells.

8. The airbag of claim 7, wherein the apertures provided in the gas diffuser are configured to diffuse gas to the plurality of cells.

9. The airbag of claim 1, wherein the first sheet of material is formed of a nylon fabric material.

10. The airbag of claim 1, wherein the gas diffuser is configured for coupling to an inflator.

11. The airbag of claim 1, wherein the airbag is a curtain airbag.

12. An airbag comprising:
a first fabric panel configured to define both at least one wall of an airbag cushion and a gas diffuser for the airbag, the gas diffuser having a generally tubular shape and having a plurality of apertures formed therein.

13. The airbag of claim 12, further comprising a second fabric panel coupled to the first sheet of material, wherein the first fabric panel and the second fabric panel define at least one chamber for the airbag cushion.

14. The airbag of claim 13, wherein the first fabric panel is coupled to the second fabric panel with stitched thread.

15. The airbag of claim 14, wherein the first fabric panel is further coupled to the second fabric panel with an adhesive.

16. The airbag of claim 12, wherein the gas diffuser comprises a first portion of the first fabric panel coupled to a second portion of the first fabric panel.

17. The airbag of claim 12, wherein the plurality of apertures in the gas diffuser are configured to allow gas to flow into a plurality of chambers provided in the airbag cushion.

18. The airbag of claim 12, wherein the first fabric panel comprises a nylon material.

19. A method of producing an airbag comprising:
providing a first fabric panel;
forming a generally tubular channel from a first portion of the first fabric panel; and
forming an inflation chamber from a second portion of the first fabric panel.

20. The airbag assembly of claim 19, wherein the tubular channel includes a plurality of apertures and acts as a gas diffuser for the airbag.

21. The airbag assembly of claim 19, wherein the step of forming the tubular channel comprises coupling a first section of the first fabric panel to a second section of the first fabric panel.

22. The airbag assembly of claim 21, wherein the step of coupling a first section of the first fabric panel to a second section of the first fabric panel utilizes an adhesive.

23. The airbag assembly of claim 19, wherein the step of coupling a first section of the first fabric panel to a second section of the first fabric panel utilizes a stitching operation.

24. The airbag assembly of claim 19, further comprising attaching a second fabric panel to the first fabric panel to further form the inflation chamber.

25. The airbag assembly of claim 19, wherein the step of forming the tubular channel comprises folding a portion of the first fabric panel.
